(19) United States
(12) Patent Application Publication
(10) Pub. No.: US 2007/0061822 A1
(43) Pub. Date: Mar. 15, 2007

(54) Clamping structure and carrying mechanism and optical disc drive using the same

(75) Inventor: Xiao-Ning Sun, Suzhou (CN)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/518,928

(22) Filed: Sep. 12, 2006

(30) Foreign Application Priority Data
Sep. 14, 2005 (TW) 94131703

(51) Int. Cl. G11B 17/04

(52) U.S. Cl. 720/604

(57) ABSTRACT

A clamping structure and a carrying mechanism and an optical disc drive using the same are provided. The clamping structure is using for clamping an article. The clamping structure includes a plate and an elastic sheet. The plate has a positioning pillar and a plurality of engaging components both of which are disposed on the plate. The elastic sheet has a fixing end and a clamping end. As the article is laid on the plate, a plurality of engaging components clamp the clamping end respectively. And as the fixing end abuts the positioning pillar, the clamping end generates an elastic force towards the plate for clamping the article on the plate.

This application claims the benefit of Taiwan application Serial No. 094131703, filed Sep. 14, 2005, the subject matter of which is incorporated herein by reference.

### BACKGROUND OF THE INVENTION

1. Field of the Invention

The invention relates in general to a clamping structure and a carrying mechanism and an optical disc drive using the same, and more particularly to a clamping structure clamping an article by an elastic sheet, and a carrying mechanism and an optical disc drive using the same.

2. Description of the Related Art

Recently, with the rapid development in digital media and information technology industry, the digital contents and audio/video products have brought tremendous convenience and pleasure to the users. Optical disc drive, which provides the functions for reading or recording a large amount of digital data and the functions for storing and playing music and films, has become an indispensable electronic product to modern people.

Referring to FIG. 1, the optical pick-up head and the carrying mechanism using of an optical disc drive using a conventional clamping structure are shown. The optical disc drive 101 has an optical pick-up head 11 and a carrying mechanism 301. The carrying mechanism 301 is used for carrying the optical pick-up head 11. The carrying mechanism 301 includes a first guiding rod 31, a second guiding rod 32 and a plurality of clamping structures 401. The optical pick-up head 11 is coupled with the first guiding rod 31 and the second guiding rod 32 for enabling the optical pick-up head 11 to slide back and forth along the first guiding rod 31 and the second guiding rod 32.

During the assembly process, the first guiding rod 31 and the second guiding rod 32 must be appropriately adjusted for enabling the first guiding rod 31 to be parallel to the second guiding rod 32. Furthermore, the co-plane formed by the first guiding rod 31 and the second guiding rod 32 must be parallel to the surface of the disc holder of the optical disc drive 101. Therefore, the optical disc drive 101 normally adopts an adjustable clamping structure 401. The clamping structure 401 includes a plate 501, an elastic sheet 601 and a screw 701. The clamping structure 401 adjusts the first guiding rod 31 and the second guiding rod 32 by using the deformability of the elastic sheet 601.

However, the conventional process of fastening the elastic sheet 601 on the plate 501 via a screw 701 requires the process of fastening the screw 701, hence increasing the labor and the working-hour cost. The purchasing cost of the screw 701 is inevitable.

### SUMMARY OF THE INVENTION

It is therefore an object of the invention to provide a clamping structure and a carrying mechanism and an optical disc drive using the same. The elastic sheet has an opening and the plate has two engaging components for enabling the article to be firmly clamped on the plate. During the process of assembly, the elastic sheet is fastened on the plate without using the screw, hence saving unnecessary waste of the labor and the working-hour cost as well as the purchasing cost for the screw.

The invention achieves the above-identified object by providing a clamping structure for clamping an article. The clamping structure includes a plate and an elastic sheet. The plate has a positioning pillar and a plurality of engaging components both of which are disposed on the plate. The elastic sheet has a fixing end and a clamping end. As the article is laid on the plate, the engaging components clamp the clamping end respectively. And as the fixing end abuts the positioning pillar, the clamping end generates an elastic force towards the plate for clamping the article on the plate.

The invention further achieves the above-identified object by providing a carrying mechanism. The carrying mechanism includes a first guiding rod, a second guiding rod, a plate and an elastic sheet. The second guiding rod is parallel to the first guiding rod. The first guiding rod and the second guiding rod are coupled with a movable component for carrying the movable component. The movable component is capable of sliding along the first guiding rod and the second guiding rod. The plate has a positioning pillar and a plurality of engaging components both of which are disposed on the plate. The elastic sheet has a fixing end and a clamping end. As the first guiding rod is laid on the plate, the engaging components clamp the clamping end respectively. And as the fixing end abuts the positioning pillar, the clamping end generates an elastic force towards the plate for clamping the first guiding rod on the plate.

The invention further achieves the above-identified object by providing an optical disc drive. The optical disc drive includes an optical pick-up head, a first guiding rod, a second guiding rod, a plate and an elastic sheet. The second guiding rod is parallel to the first guiding rod. The first guiding rod and the second guiding rod are coupled with the optical pick-up head for carrying the optical pick-up head. The optical pick-up head is capable of sliding along the first guiding rod and the second guiding rod. The plate has a positioning pillar and a plurality of engaging components both of which are disposed on the plate. The elastic sheet has a fixing end and a clamping end. As the first guiding rod is laid on the plate, the engaging components clamp the clamping end respectively. And as the fixing end abuts the positioning pillar, the clamping end generates an elastic force towards the plate for clamping the first guiding rod on the plate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) illustrates the optical pick-up head and the carrying mechanism using of an optical disc drive using a conventional clamping structure;

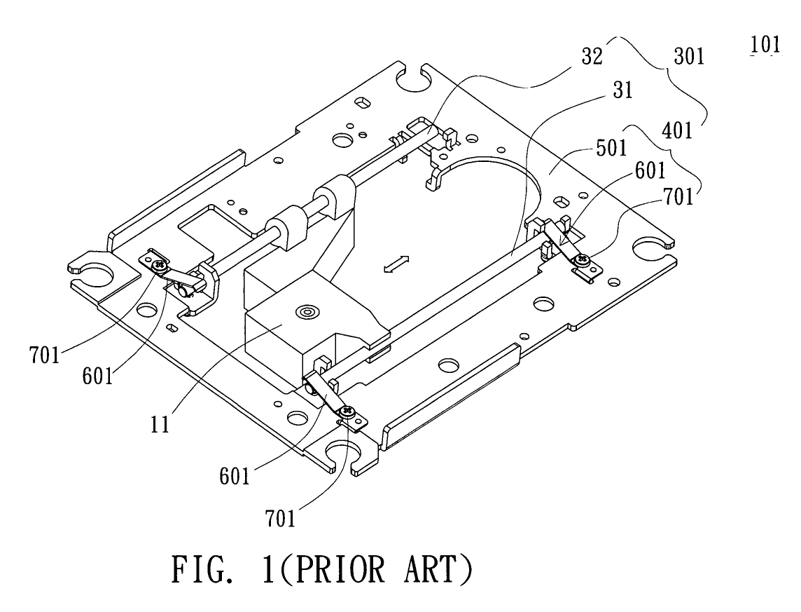

FIG. 2 illustrates the optical pick-up head and the carrying mechanism of an optical disc drive using the clamping structure according to a first embodiment of the invention;

FIG. 3 is an enlarged diagram of the first guiding rod and the plate of FIG. 2;

FIG. 4 schematically illustrates an elastic sheet being half engaged with the positioning pillar of FIG. 3;

FIG. 5 schematically illustrates the elastic sheet having been completely engaged with the engaging components of FIG. 4; and

FIG. 6 is an enlarged diagram of the clamping structure according to a second embodiment of the invention.

### DETAILED DESCRIPTION OF THE INVENTION

### First Embodiment

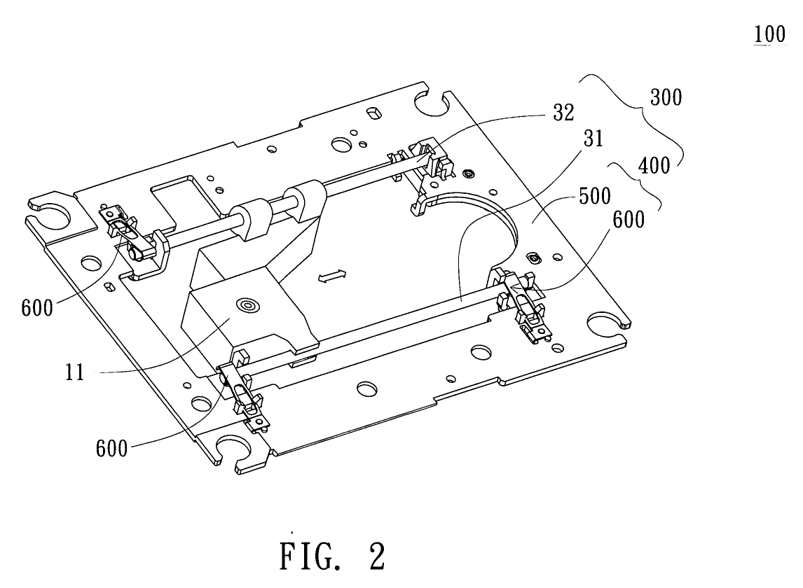

Referring to FIG. 2, the optical pick-up head and the carrying mechanism of an optical disc drive using the clamping structure according to a first embodiment of the invention are shown. The clamping structure 400 is applicable to any structures or electronic devices. In the present embodiment of the invention, the clamping structure 400 is exemplified by the application in the carrying mechanism 300 and an optical disc drive 100. The optical disc drive 100 includes a VCD-ROM, a VCD-RW, a DVD-ROM, a DVD-RW or a Combo. The optical disc drive 100 includes an optical pick-up head 11 and a carrying mechanism 300. The optical pick-up head 11 is slideably disposed on the carrying mechanism 300. The carrying mechanism 300 includes a first guiding rod 31, a second guiding rod 32 and a clamping structure 400. The clamping structure 400 includes a plate 500 and an elastic sheet 600.

The elastic sheet 600 is disposed on the plate 500. The clamping structure 400 clamps the first guiding rod 31 or the second guiding rod 32 on the plate 500 by an elastic sheet 600. The first guiding rod 31 and the second guiding rod 32 are parallel to each other and are disposed on the plate 500. Furthermore, the optical pick-up head 11 is coupled with the first guiding rod 31 and the second guiding rod 32 for enabling the optical pick-up head 11 to slide back and forth along the first guiding rod 31 and the second guiding rod 32.

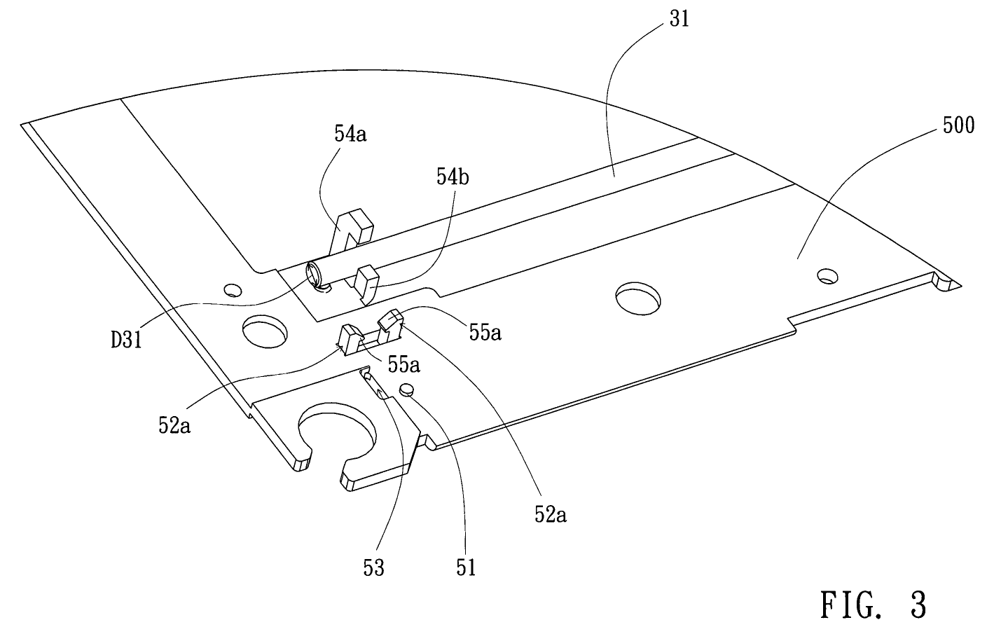

Referring to FIG. 3, an enlarged diagram of the first guiding rod and the plate of FIG. 2 is shown. The plate 500 has a positioning pillar 51, two engaging components 52a and two braces 54a and 54b, all of which are projected on the plate 500. As the first guiding rod 31 is disposed on the plate 500, one end of the first guiding rod 31 abuts the position between the two braces 54a and 54b for preventing the first guiding rod 31 from sliding or rolling. In the present embodiment of the invention, the other end of the first guiding rod 31 and one end of the second guiding rod 32 also have two braces 54a and 54b whose structures are the same and are not repeated here.

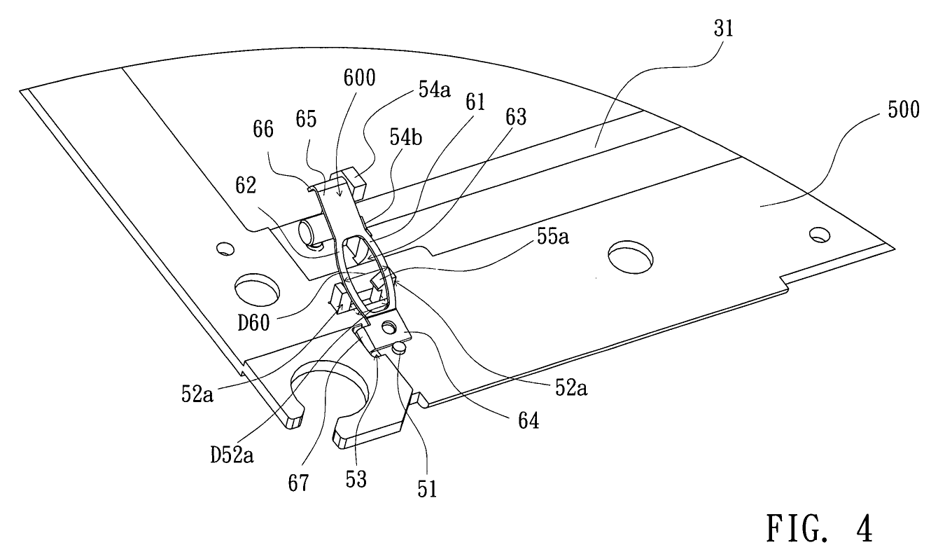

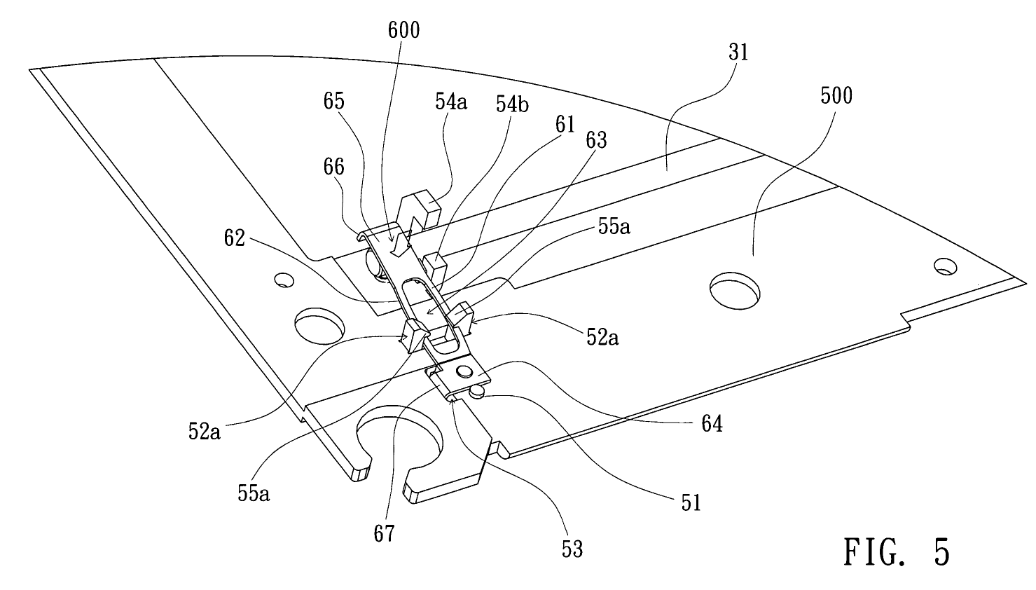

Referring to FIG. 4 and FIG. 5 at the same time. FIG. 4 schematically illustrates an elastic sheet being half engaged with the positioning pillar of FIG. 3. FIG. 5 schematically illustrates the elastic sheet having been completely engaged with the engaging components of FIG. 4. The elastic sheet 600 has an opening 63, a first elastic arm 61, a second elastic arm 62, a fixing end 64 and a positioning hook 66. The first elastic arm 61 and the second elastic arm 62 are connected with each other and are disposed between the fixing end 64 and the positioning hook 66, and are projected outwardly to form an arced structure. Furthermore, the first elastic arm 61 and the second elastic arm 62 form the opening 63 between the fixing end 64 and the positioning hook 66. The first elastic arm 61 and the second elastic arm 62 has elasticity for releasing a force to compress the first elastic arm 61 and the second elastic arm 62 towards the opening 63 or extend the first elastic arm 61 and the second elastic arm 62 towards the two outer sides.

In the present embodiment of the invention, the two engaging components 52a are disposed on the outer side of the first elastic arm 61 and the outer side of the second elastic arm 62 respectively, and the inner interval D52a between the inner sides of the two engaging components 52a is slightly smaller than the outer interval between the outer side of the first elastic arm 61 and the outer side of the second elastic arm 62 D60. The two engaging components 52a are disposed face to face, and so are the hooks 55a thereof. As the fixing end 64 of the elastic sheet 600 abuts the positioning pillar 51 and is pushed towards the position between the two engaging components 52a, the first elastic arm 61 and the second elastic arm 62 are pushed by the two hooks 55a and generate a deformation towards the inner side of the opening 63. After the elastic sheet 600 passes the hooks 55a of the two engaging components 52a, the two engaging components 52a are firmly fastened on the outer side of the first elastic arm 61 and the outer side of the second elastic arm 62 respectively.

The elastic sheet 600 further has a positioning piece 67 projected on a lateral side of the fixing end 64 and the plate 500 further has at least a positioning aperture 53. As the elastic sheet 600 is engaged between the two engaging components 52a, the positioning piece 67 is inserted into the positioning aperture 53 for preventing the elastic sheet 600 from sliding. Furthermore, the clamping end 65 of the elastic sheet 600 has a positioning hook 66 facing the first guiding rod 31 for preventing the first guiding rod 31 from sliding.

As the elastic sheet 600 is firmly fastened between the two engaging components 52a, the positioning piece 67 is inserted into the positioning aperture 53, and the fixing end 64 abuts the positioning pillar 51, the clamping end 65 of the elastic sheet 600 generates an elastic force towards the plate 500 (the direction of the arrow) for clamping the first guiding rod 31 on the plate 500.

### Second Embodiment

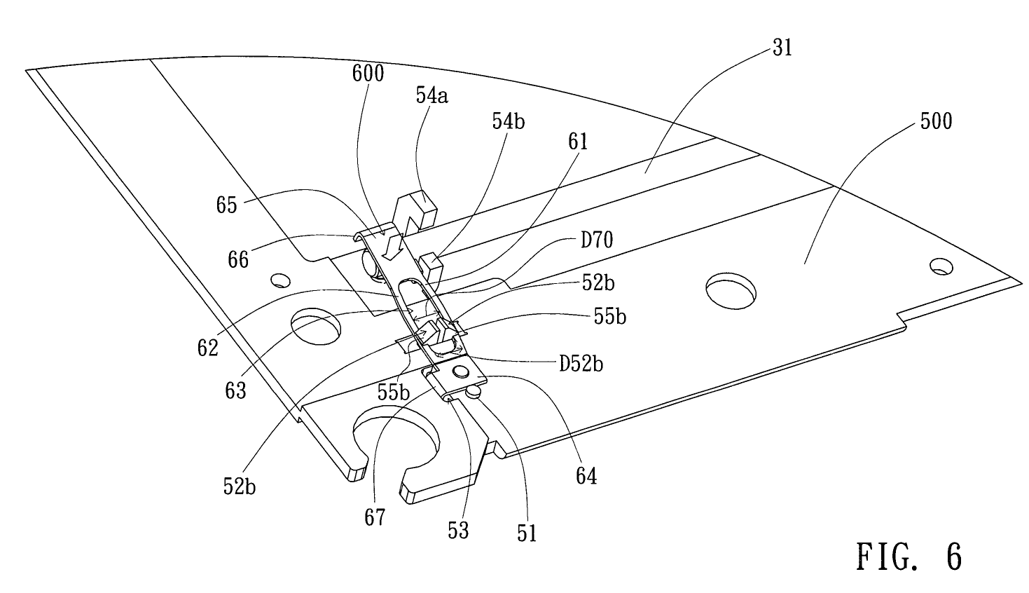

Referring to FIG. 6, an enlarged diagram of the clamping structure according to a second embodiment of the invention is shown. The clamping structure of the present embodiment of the invention and a carrying mechanism and an optical disc drive using the same differs with the clamping structure of the first embodiment in the disposition of the two engaging components 52b. As for other similarities are not repeated here.

The two engaging components 52b are disposed on the inner side of the first elastic arm 61 and the inner side of the second elastic arm 62 respectively, and the outer interval D52b between the outer sides of the two engaging components 52b is slightly larger than the inner interval D70 between the outer side of the first elastic arm 61 and the inner side of the second elastic arm 62. The two engaging components 52b are disposed back to back, and so are the hooks 55b thereof. As the fixing end 64 of the elastic sheet 600 abuts the positioning pillar 51 and is pushed towards the position between the two engaging components 52b, the first elastic arm 61 and the second elastic arm 62 are pushed by the two hooks 55b and generate a deformation towards the outer side of the opening 63. Therefore, the elastic sheet 600 is able to pass the hooks 55b projected on the two engaging components 52b. Furthermore, the two engaging components 52b are firmly fastened on the inner side of the first elastic arm 61 and the inner side of the second elastic arm 62 respectively.

In the above two embodiments, the clamping structure of the invention is exemplified by two engaging components. However, examples of the clamping structure of the invention include a pin or a groove. During the process of assembly, any design capable of fastening the elastic sheet without using screw is within the scope of technology of the invention.

The clamping structure disclosed in the above embodiments of the invention is exemplified by the application in the carrying mechanism and the optical disc drive. However, the clamping structure of the invention is applicable to other structures such as the pitman arm shaft of an optical disc drive. The pitman arm shaft, which vibrates when the optical disc drive is operating, is fastened by an elastic sheet. Currently, the elastic sheet is fastened by a conventional screw. The elastic sheet of the pitman arm shaft can adopt the clamping structure of the invention. During the process of assembly, any design capable of fastening the elastic sheet without using screw is within the scope of technology of the invention.

Despite the above embodiments of the invention are exemplified by two engaging components, however, the number of the engaging components of the invention is not limited thereto. For example, the case of four engaging components would do as well. Despite the clamping end exemplified in the above embodiments of the invention has an opening, a first elastic arm and a second elastic arm, however, the clamping end of the invention can do without an opening. The clamping end of the invention, when pushed by the elasticity of the clamping end, is capable of being engaged with the engaging components. During the process of assembly, any design capable of fastening the elastic sheet without using screw is within the scope of technology of the invention.

According to the clamping structure and the carrying mechanism and the optical disc drive using the same disclosed in the above embodiments of the invention, the elastic sheet has an opening and the plate has two engaging components for enabling the article to be firmly clamped on the plate. During the process of assembly, the elastic sheet is fastened on the plate without using the screw, hence saving the process of fastening the screw as well as the waste of the laber, working-hour and the purchasing cost of the screw.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A clamping structure used for clamping an article, wherein the clamping structure comprises:
a plate having a positioning pillar and a plurality of engaging components both of which are disposed on the plate; and
an elastic sheet having a fixing end and a clamping end, wherein when the article is laid on the plate, the engaging components respectively clamp the clamping end, and when the fixing end abuts the positioning pillar, the clamping end generates an elastic force towards the plate for clamping the article on the plate.

2. The clamping structure according to claim 1, wherein the clamping end of the elastic sheet further has an opening, a first elastic arm and a second elastic arm, wherein the first elastic arm and the second elastic arm are positioned on the two sides of the opening respectively, and when the article is laid on the plate, the engaging components clamp the first elastic arm and the second elastic arm respectively.

3. The clamping structure according to claim 2, wherein the engaging components are fastened on the outer side of the first elastic arm and the outer side of the second elastic arm respectively.

4. The clamping structure according to claim 3, wherein the engaging components further have hooks disposed face to face, wherein the first elastic arm and the second elastic arm are pushed by the hooks and generate a deformation towards the inner side of the opening.

5. The clamping structure according to claim 2, wherein the engaging components further have hooks disposed face to face, wherein the engaging components are fastened on the inner side of the first elastic arm and the inner side of the second elastic arm respectively.

6. The clamping structure according to claim 5, wherein the engaging components further have hooks disposed back to back, wherein the first elastic arm and the second elastic arm are pushed by the hooks and generate a deformation towards the outer side of the opening.

7. The clamping structure according to claim 2, wherein the first elastic arm and the second elastic arm are an arced structure.

8. The clamping structure according to claim 1, wherein the elastic sheet further has a positioning piece, the plate further has a positioning aperture, and the positioning piece is projected on a lateral side of the fixing end and inserted into the positioning aperture for preventing the elastic sheet from sliding.

9. The clamping structure according to claim 1, wherein the clamping end of the elastic sheet has a positioning hook facing the article for preventing the article from sliding.

10. The clamping structure according to claim 1, wherein the plate further has at least a brace disposed on the plate, and when the article is laid on the plate, the article is retained by the brace used for preventing the article from sliding to the side.

11. An optical disc drive, comprising:
an optical pick-up head;
a first guiding rod;
a second guiding rod parallel to the first guiding rod, wherein the first guiding rod and the second guiding rod are coupled with the optical pick-up head for carrying the optical pick-up head capable of sliding along the first guiding rod and the second guiding rod;
a plate having a positioning pillar and a plurality of engaging components both of which are disposed on the plate; and
an elastic sheet having a fixing end and a clamping end, when the first guiding rod is disposed on the plate, the engaging components respectively clamp the clamping end, and when the fixing end abuts the positioning pillar, the clamping end generates an elastic force towards the plate for clamping the first guiding rod on the plate.

12. The clamping structure according to claim 11, wherein the clamping end of the elastic sheet further has an opening, a first elastic arm and a second elastic arm, wherein the first elastic arm and the second elastic arm are positioned on the two sides of the opening respectively, and when the article is laid on the plate, the engaging components clamp the first elastic arm and the second elastic arm respectively.

13. The optical disc drive according to claim 12, wherein the engaging components are fastened on the outer side of the first elastic arm and the outer side of the second elastic arm respectively.

14. The optical disc drive according to claim 13, wherein the engaging components further have hooks disposed face to face, wherein the first elastic arm and the second elastic arm are pushed by the hooks and generate a deformation towards the inner side of the opening.

15. The optical disc drive according to claim 12, wherein the engaging components are fastened on the inner side of the first elastic arm and the inner side of the second elastic arm respectively.

16. The clamping structure according to claim 15, wherein the engaging components further have hooks disposed back to back, wherein the first elastic arm and the second elastic arm are pushed by the hooks and generate a deformation towards the outer side of the opening.

17. The optical disc drive according to claim 12, wherein the first elastic arm and the second elastic arm are an arced structure.

18. The optical disc drive according to claim 11, wherein the elastic sheet further has a positioning piece disposed on a lateral side of the fixing end, the plate further has a positioning aperture, and the positioning piece is inserted into the positioning aperture for preventing the elastic sheet from sliding.

19. The optical disc drive according to claim 11, wherein the clamping end of the elastic sheet has a positioning hook facing the first guiding rod for preventing the guiding rod from sliding.

20. The optical disc drive according to claim 11, wherein the plate further has at least a brace disposed on the plate, and when the guiding rod is disposed on the plate, the first guiding rod is retained by the brace used for preventing the guiding rod from sliding.
